(19) United States
(12) Patent Application Publication
(10) Pub. No.: US 2024/0297291 A1
(43) Pub. Date: Sep. 5, 2024

(54) FLAT LITHIUM PRIMARY BATTERY

(71) Applicant: Panasonic Intellectual Property Management Co., Ltd., Osaka (JP)

(72) Inventor: TOMOHIRO YAGISHITA, Osaka (JP)

(21) Appl. No.: 18/572,848

(22) PCT Filed: May 16, 2022
(86) PCT No.: PCT/JP2022/020374

§ 371 Date: Dec. 21, 2023

(30) Foreign Application Priority Data
Jul. 13, 2021 (JP) 2021-115864

(51) Int. Cl. H01M 4/13; H01M 4/02; H01M 4/50; H01M 4/62; H01M 6/14

(52) U.S. Cl. CPC H01M 4/13; H01M 4/502; H01M 4/623; H01M 4/625; H01M 6/14; H01M 2004/028; H01M 2300/0017

(57) ABSTRACT

A flat lithium primary battery includes a case, a positive electrode, a negative electrode, a separator, and a non-aqueous electrolyte. The positive electrode includes a positive electrode pellet containing positive electrode active material, conductive agent, and binder. The positive electrode pellet has a circular columnar shape having a side circumferential surface extending in a circumferential direction surrounding a center axis extending in a center axis direction. The conductive agent contains graphite. The positive electrode pellet is divided into first and second portions. The first portion includes at least a part of the side circumferential surface of the circular columnar shape. The first portion includes an annular portion surrounding at least a part of the second portion. A content of the graphite in the second portion of the positive electrode pellet is higher than in the first portion of the positive electrode pellet.

### TECHNICAL FIELD

The present disclosure relates to a flat lithium primary battery.

### BACKGROUND ART

Flat lithium primary batteries have high energy density and can output a high voltage. The flat lithium primary batteries therefore have been used as power sources for various electronic equipment.

Various types of flat lithium primary batteries have been proposed. For example, PTL 1 proposes a non-aquas electrolyte battery in which a recess is formed in the center of a surface of the positive electrode mixture on its side contacting a separator, and the density at the center of the recess is higher than the density at the circumferential protruded portion.

### CITATION LIST

### Patent Literature

PTL 1: Japanese Utility Model Laid-Open Publication No. 2-138852

### SUMMARY OF INVENTION

A positive electrode expands during discharge. The expansion of the positive electrode may cause a battery case (a positive electrode can) to deform. While the expansion of the positive electrode may occur at both the center and the side circumference of the positive electrode pellet, the positive electrode basically expands uniformly. On the other hand, the positive electrode can deform such that the corner between a tubular portion and a bottom portion of the positive electrode serves as a support for expansion and the bottom portion expands. As a result, the deformation of the bottom portion of the positive electrode is larger at the center thereof which is away from the corner. This deformation may prevent the positive electrode can from contacting and the positive electrode pellet sufficiently at the center of the bottom portion.

This may cut the electrical connection of the positive electrode pellet with the positive electrode can more easily at the center of the positive electrode pellet than at the side circumference, accordingly increasing an internal resistance of the battery. This may cause the battery to hardly have an adequate discharge capacity.

Particularly in the configuration of the lithium primary battery disclosed by PTL 1, a positive electrode pellet easily expands at its side circumference while the expansion at the center thereof having the recessed shape is suppressed. This may cut the electrical connection of the positive electrode pellet with the positive electrode can at the center thereof, hardly suppressing an increase of a resistance during discharge sufficiently. As a result, this may cause the battery to hardly have a high discharge capacity.

It may be thought to provide a current collector such, for example, as an L-shaped ring or an expanded metal to improve the electrical connection between the positive electrode pellet and the positive electrode can. However, this causes the volume of the elements for generating electricity to be reduced by the volume occupied by the current collector, so that the discharge capacity is reduced.

A flat lithium primary battery in accordance with an aspect of the present disclosure includes a case, a positive electrode, a negative electrode, a separator, and a non-aqueous electrolyte. The positive electrode includes a positive electrode pellet containing positive electrode active material, conductive agent, and binder. The positive electrode pellet has a circular columnar shape having a side circumferential surface extending in a circumferential direction surrounding a center axis extending in a center axis direction. The conductive agent contains graphite. The positive electrode pellet is divided into first and second portions. The first portion includes at least a part of the side circumferential surface of the circular columnar shape. The first portion includes an annular portion surrounding at least a part of the second portion. A content of the graphite in the second portion of the positive electrode pellet is higher than in the first portion of the positive electrode pellet.

This flat lithium primary battery has a large discharge capacity.

### BRIEF DESCRIPTION OF DRAWINGS

FIG. 1A is a schematic sectional view of a lithium primary battery according to an exemplary embodiment of the present disclosure.

FIG. 1B is a plan view of the lithium primary battery shown in FIG. 1A for illustrating a positive electrode thereof.

FIG. 2 shows examples of distribution profiles and arrangements of first and second portions in a positive electrode pellet.

FIG. 3 shows examples of distribution profiles and arrangements of first and second portions in the positive electrode pellet.

### DESCRIPTION OF EMBODIMENTS

Hereinafter, an exemplary embodiment of the present disclosure will be described. Although an exemplary embodiment of the present disclosure will be described in the following description, it should be noted that the present invention is not limited to the described exemplary embodiment. Although specific numerical values and materials will sometimes be exemplified in the following description, other numerical values and materials may be applied as far as advantageous effects of the present disclosure can be obtained.

### Flat Lithium Primary Battery

A flat lithium primary battery according to an exemplary embodiment of the present disclosure (hereinafter referred to simply as “lithium primary battery”) includes a case, a positive electrode, a negative electrode, a separator, and a non-aqueous electrolyte. The case accommodating therein the positive electrode, the negative electrode, the separator, and the non-aqueous electrolyte. The positive electrode and the negative electrode face each other across the separator intervening between the electrodes. The positive electrode includes a positive electrode pellet having a circular columnar shape and containing positive electrode active material, conductive agent, and binder. The conductive agent contained in the positive electrode contains graphite.

The positive electrode pellet is accommodated in and electrically connected to a case. The case of the positive electrode pellet may be called “a positive electrode case” or “a positive electrode can.” This case thus functions as a positive electrode terminal.

The positive electrode pellet often has a circular columnar shape (or a disk shape) having a side circumferential surface extending in a circumferential direction surrounding a center axis of the circular columnar shape. The circular columnar shape of the positive electrode pellet has a top surface and a bottom surface which are located at opposite ends from each other in the direction of the center axis and which are connected to the side circumferential surface. The top and bottom surfaces of the circular columnar shape of the positive electrode pellet are defined such that the bottom surface of the circular columnar shape is a surface electrically connected to the case of the positive electrode pellet (the positive electrode can) and the top surface of the circular columnar shape is a surface facing the negative electrode across the separator.

The positive electrode pellet is divided into a first portion and a second portion. The first portion includes at least a part of the side circumferential surface of the circular columnar shape. As described later, the first portion and the second portion are different from each other in the content of the graphite. The first portion includes at least a part of the side circumferential surface of the circular columnar shape. The second portion is a region which is surrounded by the first portion and which includes, for example, the center of the circular columnar shape. The first portion includes an annular portion surrounding at least a part of the second portion. The at least the part of the side circumferential surface of the circular columnar shape included in the first portion surrounds the center axis over an entire circumference of the side circumferential surface in the circumferential direction.

The content of the graphite in the second portion of the positive electrode pellet is larger than in the first portion. The positive electrode is more likely to expand during discharge as the content of the graphite contained in the material constituting the positive electrode increases. Accordingly, by increasing the content of the graphite in the second portion to be higher than that in the first portion, or lowering the content of the graphite in the first portion to be lower than that in the second portion, expansion at the side circumference of the positive electrode pellet is relatively suppressed, so that the positive electrode pellet may expand to allow the center to expand with respect to the side circumference. Consequently, as the positive electrode pellet expands, the case expands while allowing the positive electrode pellet to contact the positive electrode can, thus maintaining a preferable electrical connection between the positive electrode pellet and the case. This configuration suppresses an increase of an internal resistance of the battery during discharge. Further, energy stored in the battery may be effectively used until an end of life of the battery, thus increasing its discharge capacity.

In order to suppress the expansion of the positive electrode pellet at the side circumference and to facilitate the expansion of the positive electrode pellet at the center, or the region near the center axis of the circular columnar shape, the content of the graphite in the second portion is larger than the content of the graphite in the first portion preferably by four (4) parts by mass or more of the positive electrode pellet. In order to suppress the expansion of the positive electrode pellet at the side circumference, the content of the graphite in the first portion may be equal to or smaller than four (4) parts by mass. In the above description, the content of the graphite is a value of parts by mass with respect to 100 parts by mass of the positive electrode active material.

A material used as the conductive agent added to the positive electrode and the negative electrode is carbon material, such as hard carbon, soft carbon and graphite. Graphite among the carbon materials has a planarly developed graphene layer in which carbon atoms are bound in a hexagonal lattice structure. As the graphene layer develops larger, the volume of the graphite particle increases, so that each graphite particle may contact plural particles of the positive electrode active material. In the case, e.g., where one graphite particle contacts two positive electrode active material particles, the graphite particle contacts a surface of one of the positive electrode active material particles in a certain graphene layer. The graphite particle may contact the surface of the other of the positive electrode active material particles in the above-mentioned graphene layer, or may contact a surface of the other of the positive electrode active material particles in an upper or lower graphene layer laminated on the graphene layer with which the one of the positive electrode active materials is in contact. When one of the positive electrode active material particles expands due to discharge, the graphite particle contacting the one of the positive electrode active material particles acts as a lever to move the other of the positive electrode active material particles. As a result, in the second portion, where the content of the graphite is larger, the expansion of the positive electrode pellet is effectively promoted while maintaining a certain extent of inter-particle distance between the positive electrode active material particles.

The graphite means a material in which the graphite type crystal structure is developed, and generally is a carbon material in which an average interplanar distance d₀₀₂ of the (002) planes measured by the X-ray diffraction method is 0.340 nm or shorter. Examples of graphite include earthy graphite, scaly graphite, flake graphite, and expanded graphite. The expanded graphite is a material having an expanded interlayer distance formed by intercalating an acid constituent, such as sulfuric acid, into the spaces between the graphene layers of the graphite and heating to vaporize the acid constituent. The graphene including one to ten graphene layers may be included in the graphite. 90% by mass or more of the conductive agent is preferably occupied by the graphite.

In order to adequately develop the graphene layer in the planar direction and likely exert advantageous effects of the present disclosure, the graphite preferably contains at least one selected from the group consisting of the expanded graphite, the flake graphite and the graphene. 90% by mass or more of the graphite is preferably occupied by at least one selected from the group consisting of the expanded graphite, the flake graphite and the graphene.

As the flexibility of the graphite is higher, or the stiffness of the graphite is lower, the adhesiveness of the graphite and the particles of the positive electrode active material increases at the time of molding the pellet. On the other hand, as the flexibility of the graphite is lower, or the stiffness of the graphite is higher, the expansion of the particles of the positive electrode active material is more likely to contribute to the expansion of the positive electrode pellet. the expanded graphite, the flake graphite and the graphene among the various types of graphite have a layered structure and a flat shape. The long side of the flat shape relates to the particle size. The thickness of the flat shape is shorter than the length of the long side. Accordingly, the interlayer distance and the thickness relate to the flexibility and the stiffness. The flake graphite is preferable in order to have a high stiffness due to its small interlayer distance and large thickness. The graphene is preferable in order to have a high flexibility due to its small thickness although its interlayer distance is small. The expanded graphite is most preferable because its flexibility and stiffness are balanced due to its large interlayer distance and large thickness. The graphene may have a single graphene layer or two or more laminated hexagonal mesh layers (for example, about 10 layers).

In the configuration of the positive electrode pellet, the first portion having a smaller content of the graphite is a region including the side circumferential surface of the positive electrode pellet (the side circumferential surface of the circular columnar shape) and surrounds at least a part of the second portion having a larger content of the graphite. The first portion may have an annular shape along the side circumferential surface of the positive electrode pellet so as to surround the second portion. The thickness (width) of the annular portion in the direction of the center axis of the positive electrode pellet (the center axis of the circular columnar shape) may be equal to or smaller than the width of the side circumferential surface of the positive electrode pellet (the height of the circular columnar shape). In other words, the second portion may be exposed at a part of the side circumferential surface on the top surface side and/or the bottom surface side of the positive electrode pellet with the circular columnar shape.

In the configuration of the positive electrode pellet, the second portion having a larger content of the graphite may be a region including at least a part of the center axis of the positive electrode pellet (the center axis of the circular columnar shape). The second portion may be a region having the same thickness as the thickness of the positive electrode pellet in the axial direction of the circular columnar shape to include the entire of the center axis of the positive electrode pellet (the center axis of the circular columnar shape). The thickness of the second portion in the axial direction of the circular columnar shape may be smaller than the thickness of the positive electrode pellet. In other words, either the first or second portion may be exposed in the region including the center axis on the top surface and/or the bottom surface of the positive electrode pellet with the circular columnar shape.

When the positive electrode pellet is viewed in the center axis direction, as the cross-sectional area of the annular portion of the first portion on a cross-section perpendicular to the center axis is larger than the cross-sectional area of the second portion, the expansion at the side circumferential surface of the positive electrode pellet is more suppressed, so that the positive electrode pellet expands more at the center than at the side circumference. As a result, the amount of expansion at the bottom including the bottom surface of the positive electrode pellet is larger at the center portion near the center axis than at the side circumference portion near the side circumferential surface, so that the positional difference in the center axis direction between the side circumference portion and the center portion becomes large. In the positive electrode pellet, the minimum distance to the annular portion of the first portion from the center axis of the positive electrode pellet may preferably be 90% or less (more preferably 80% or less) of the radius of the positive electrode pellet. In other words, in the positive electrode pellet, the distance from the center axis of the positive electrode pellet to the border between the annular portion of the first portion and the second portion may preferably 90% or less, more preferably 80% or less, of the radius of the positive electrode pellet. This configuration allows the expansion of the positive electrode pellet to be adequately larger at the center portion than at the side circumference portion. Accordingly, even in the case where the case (the positive electrode can) expands, the battery maintains a preferable electrical connection between the positive electrode pellet and the case.

The positive electrode pellet expands selectively more at the second portion than at the first portion. This maintains a preferable electrical connection between the positive electrode pellet and the case (the positive electrode can) even in the case where the case expands. In this case, the area of the positive electrode pellet at which a preferable electrical connection with the case is maintained, mainly the area of the second portion contacting the case, may be adequately large to enhance the effect of suppressing the increase of the internal resistance during discharge, thus increasing the discharge capacity. From this point of view, in the positive electrode pellet, the maximum distance to the second portion from the center axis of the positive electrode pellet may preferably be 50% or more, more preferably be 60% or more, of the radius of the positive electrode pellet. In other words, in the positive electrode pellet, the distance from the center axis of the positive electrode pellet to the border between the annular portion of the first portion and the second portion may preferably 50% or more, and more preferably 60% or more, of the radius of the positive electrode pellet.

In the positive electrode pellet, the distance from the center axis of the positive electrode pellet to the border between the annular portion of the first portion and the second portion may preferably be 50% or more and 90% or less of the radius of the positive electrode pellet, and more preferably be 60% or more and 80% or less of the radius of the positive electrode pellet.

The thickness (width) of the first portion at the annular portion in the center axis direction may preferably be 50% or more of the thickness of the positive electrode pellet. Similarly, the thickness of the second portion in the center axis direction may preferably be 50% or more of the thickness of the positive electrode pellet. The positions of the annular portion and the second portion in the center axis direction inside the positive electrode pellet may not particularly be limited, and may be disposed closer to the positive electrode can in the positive electrode pellet or may be disposed closer to the negative electrode or the separator in the positive electrode pellet.

The positive electrode pellet including the first portion and the second portion as described above may be produced by, for example, putting a positive electrode mixture for forming the first portion in a mold to temporarily mold the first portion, placing the temporarily molded first portion and a positive electrode mixture for forming the second portion in a mold for forming the positive electrode pellet, and pressure molding the whole body into a pellet shape. As another method, the positive electrode pellet may be produced by, for example, putting a positive electrode mixture for forming the second portion in a mold to temporarily mold the second portion, placing the temporarily molded second portion and a positive electrode mixture for forming the first portion in a mold for forming the positive electrode pellet, and pressure molding the whole body into a pellet shape. The mold for forming the first portion and a part of the mold for forming the positive electrode pellet may be commonly used. The positive electrode mixture for forming the first portion and the positive electrode mixture for forming the second portion each contains positive electrode active material, conductive agent, and binder, but are different from each other in the content of the graphite contained in the conductive agent. The content of the graphite contained in the positive electrode mixture for forming the first portion is smaller than the content of the graphite contained in the positive electrode mixture for forming the second portion.

In the positive electrode pellet, the binder contained in the first portion may be different from the binder contained in the second portion. The second portion may preferably contain, as the binder, polytetrafluoroethylene (PTFE) in order to avoid obstructing the expansion promotion effect of the graphite. PTFE is highly flexible because it constitutes such a binding structure that PTFE fibers entangle with the active material and the conductive agent in a reticulated pattern, so that PTFE does not substantially obstruct the expanding action of the positive electrode pellet caused by the graphite. On the other hand, the first portion may preferably contain, as the binder, fluorinated-ethylene-propylene (FEP) in order to suppress the expansion of the positive electrode at the first portion. FEP powder may be molten by heating at a high temperature so that molten FEP particles wet and spread into the active material and the conductive agent. The spread molten FEP particles resolidify to constitute a binding structure in which FEP particles securely contacting particles of the active material and the conductive agent, so that expansion of the positive electrode pellet can be easily suppressed.

A configurations of a lithium primary battery according to an exemplary embodiment of the present disclosure will be described more specifically below.

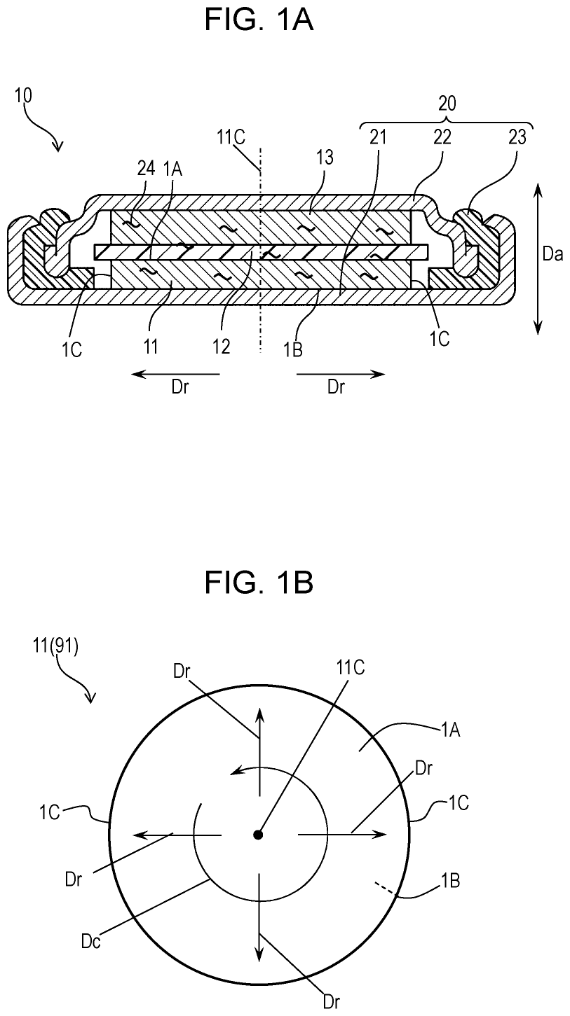

A configuration example of the lithium primary battery (a coin type or a button type) according to the exemplary embodiment is shown in a sectional view of FIG. 1A. Lithium primary battery 10 shown in FIG. 1A includes positive electrode 11, separator 12, negative electrode 13, and case 20. Case 20 includes positive electrode case 21 configured to function as a positive electrode terminal, seal plate 22 configured to function as a negative electrode terminal, and gasket 23 disposed between positive electrode case 21 and sealing plate 22. Positive electrode 11 and negative electrode 13 which face each other across separator 12 intervening between the electrodes.

Positive electrode 11, separator 12, negative electrode 13, gasket 23, and non-aqueous electrolyte 24 are disposed between positive electrode case 21 and sealing plate 22. The top of positive electrode case 21 is bent inward and crimped to seal positive electrode case 21.

FIG. 1B is a plan view of positive electrode 1. Positive electrode 11 includes positive electrode pellet 91 which contains positive electrode active material, conductive agent, and binder and which is a molded body pressure-molded to have a pellet shape (a circular columnar shape). Positive electrode pellet 91 has side circumferential surface 1C, top surface 1A, and bottom surface 1B. Side circumferential surface 1C extends in circumferential direction Dc surrounding center axis 11C that extends in center axis direction Da, which is along up and down directions. Top surface 1A and bottom surface 1B are connected to side circumferential surface 1C and positioned at ends of the pellet opposite to each other in the direction of center axis 11C. The conductive agent contains a graphite. Positive electrode 11 is divided into first portion 11A and second portion 11B according to a difference in composition. First portion 11A may be disposed along the side circumferential surface 1C (for example, circularly) so as to include at least a part of side circumferential surface 1C of the circular columnar shape and to surround at least a part of second portion 11B. Second portion 11B is the remaining part of positive electrode 11 excluding first portion 11A. The content of the graphite in second portion 11B is larger than the content of the graphite in first portion 11A. First portion 11A has includes part 1D of side circumferential surface 1C of positive electrode pellet 91. Part 1D of side circumferential surface 1C extends along the side circumferential surface 1C over the entire circumference in circumferential direction Dc. Part 1D of side circumferential surface 1C may be the entirety of side circumferential surface 1C. Part 1D of side circumferential surface 1C may be a part of side circumferential surface 1C. In this case, second portion includes a part 1E of side circumferential surface 1C of positive electrode pellet 91.

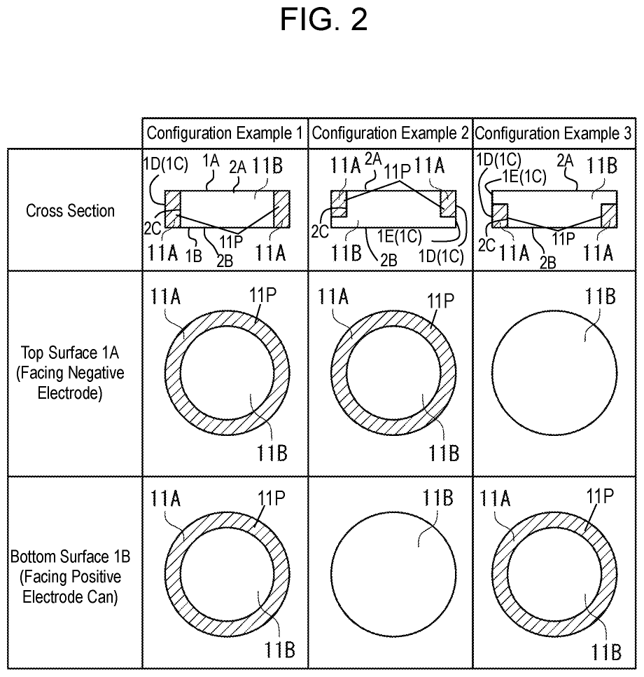

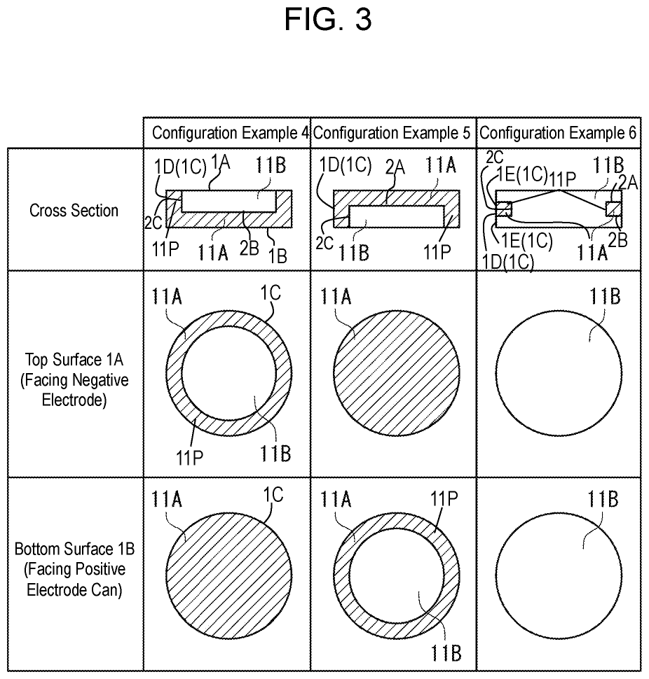

FIGS. 2 and 3 show examples of distribution profile and arrangement of first portion 11A and second portion 11B in positive electrode 11. FIGS. 2 and 3 show, in each of configuration examples 1-6, a distribution profile of first portion 11A and second portion 11B in a cross-section of positive electrode 11 on a plane including center axis 11C of positive electrode 11, a distribution profile of first portion 11A and second portion 11B on top surface 1A of positive electrode 11, and a distribution profile of first portion 11A and second portion 11B on bottom surface 1B of positive electrode 11. Top surface 1A of positive electrode 11 is a negative-electrode-opposing surface facing negative electrode 13, and bottom surface 1B is a positive-electrode-case opposing surface facing positive electrode case 21.

In each of configuration examples 1-6, first portion 11A includes annular portion 11P extending in circumferential direction Dc over the entire circumference along the side circumferential surface 1C of positive electrode 11 with a circular columnar shape. Annular portion 11P surrounds side circumferential surface 2C of second portion 11B. Annular portion 11P is exposed over the entire circumference in circumferential direction Dc of side circumferential surface 1C of positive electrode 11. However, side circumferential surface 1C may have, at a part in circumferential direction Dc, a region in which first portion 11A is not exposed and second part 11B is exposed. Second portion 11B may have substantially a circular columnar shape corresponding to the shape of positive electrode 11. In such case, top surface 2A and bottom surface 2B of second portion 11B may be defined similarly to top surface 1A and bottom surface 1B of positive electrode 11 (positive electrode pellet 91). That is, top surface 2B of second portion 11B faces negative electrode 13, and bottom surface 2B of second portion 11B faces positive electrode case 21.

In configuration example 1 shown in FIG. 2, first portion 11A is annular portion 11P exposed over the entire circumference of side circumferential surface 1C of positive electrode 11 and which is distant by a predetermined distance or more from center axis 11C of the positive electrode 11 with a circular columnar shape. In this case, second portion 11B is a region in which the distance from the center axis 11C of the positive electrode 11 with a circular columnar shape is smaller than the predetermined distance. The thickness (width) of each of first portion 11A and second portion 11B in center axis direction Da is equal to the thickness of positive electrode 11 in center axis direction Da (the height of the circular columnar shape). In this case, each of top surface 1A and bottom surface 1B of positive electrode 11 has both a region in which first portion 11A is exposed and a region in which second portion 11B is exposed. On each of top surface 1A and bottom surface 1B of positive electrode 11, first portion 11A is exposed on the circumferential surface 1C side and second portion is exposed on the center axis 11C side.

The border between first portion 11A and second portion 11B is defined by a distance from the center axis 11C of positive electrode 11. The distance defining the border between first portion 11A and second portion 11B may preferably be 50% or more and 90% or less of the radius of positive electrode 11, and more preferably be 60% or more and 80% or less of the radius of positive electrode 11.

As shown in configuration examples 2 and 3 in FIG. 2, the thickness (width) of first portion 11A in center axis direction Da may be smaller than the thickness of positive electrode 11 in center axis direction Da (the height of the circular columnar shape). In this case, first portion 11A is not exposed and only second portion 11B is exposed on at least one of top surface 1A and bottom surface 1B of positive electrode 11. In configuration example 2, second portion 11B is exposed over the entire surface of bottom surface 1B of positive electrode 11. In configuration example 3, second portion 11B is exposed over the entire surface of top surface 1A of positive electrode 11.

As shown in configuration examples 4 and 5 in FIG. 3, first portion 11A may cover side circumferential surface 2C of second portion 11B and further cover at least one of top surface 2A and bottom surface 2B of second portion 11B. In this case, second portion 11B is not exposed and only first portion 11A is exposed on at least one of top surface 1A and bottom surface 1B of positive electrode 11. In configuration example 4, first portion 11A covers bottom surface 2B of second portion 11B, and first portion 11A is exposed over the entire surface of bottom surface 1B of positive electrode 11. In configuration example 5, first portion 11A covers top surface 2A of second portion 11B, and first portion 11A is exposed over the entire surface of top surface 1A of positive electrode 11. In configuration examples 4 and 5 shown in FIG. 3, annular portion 11P is the portion of first portion 11A which is perpendicular to center axis 11C and faces second portion 11B in radial direction Dr away from center axis 11C. The thickness (width) of annular portion 11P in center axis direction Da is equal to the thickness of second portion 11B in center axis direction Da.

In configuration example 6 shown in FIG. 3, similarly to configuration examples 2 and 3, the thickness (width) of first portion 11A in center axis direction Da is smaller than the thickness of positive electrode 11 in center axis direction Da (the height of the circular columnar shape). In this example, first portion 11A is not exposed and only second portion 11B is exposed on both of top surface 1A and bottom surface 1B of positive electrode 11.

The thickness (width) of first portion 11A that constitutes annular portion 11P in center axis direction Da may preferably be 50% or more of the thickness of positive electrode 11 in center axis direction Da (the height of the circular columnar shape).

Positive electrode 11 (positive electrode pellet 91) in each of configuration examples 1-3 and 6 can be produced by, for example, putting a positive electrode mixture for first portion 11A in a mold and temporarily molding first portion 11A, then placing the temporarily-molded first portion 11A and a positive electrode mixture for second portion 11B in a mold for forming positive electrode pellet 91, and then pressure-molding the whole body into a pellet. On the other hand, positive electrode 11 (positive electrode pellet 91) in each of configuration examples 4 and 5 may be produced by, for example, putting a positive electrode mixture for second portion 11B in a mold and temporarily molding second portion 11B, then placing the temporarily-molded second portion 11B and a positive electrode mixture for first portion 11A in a mold for forming the positive electrode pellet, and pressure-molding the whole body into a pellet.

The battery is not particularly limited in structural components of the positive electrode other than those described above and structural components of the battery other than the positive electrode (for example, the negative electrode, the separator, the non-aquas electrolyte, and the case). The battery may include other structural components other than those describe above (for example, a current collector). Any known components used for the general lithium primary batteries may be used for the other components than the positive electrode.

Examples of the other structural components of the lithium primary batteries will be described below.

### Positive Electrode

The positive electrode contains positive electrode active material. The positive electrode may contain other substances (for example, any known substances used for the positive electrodes of the general lithium primary batteries). The positive electrode contains binder (binding agent) and conductive agent. The conductive agent contains graphite. The conductive agent may contain materials other than graphite. The other materials include carbon-based materials, such as carbon black (for example, ketjen black). Materials that may be used as the binder include polytetrafluoroethylene (PTFE), perfluoroalkoxy alkane (PFA), fluorinated-ethylene-propylene (FEP), and fluorocarbon resins, such as ethylene tetrafluoroethylene copolymer (ETFE) and polyvinylidene fluoride (PVDF).

The mass of the binder contained in the positive electrode may range from 1.2% to 6% (for example, from 1.5% to 3%) of the mass of the positive electrode active material contained in the positive electrode. The content of the binder in this range allows the positive electrode to be produced easily particularly with high productivity.

The positive electrode active material contained in the positive electrode may be manganese dioxide. The positive electrode containing manganese dioxide exhibits a relatively high voltage and is superior in the pulse discharge characteristics. Manganese oxide may be in a mixed crystal state containing two or more kinds of crystal states. The positive electrode may contain manganese oxides other than manganese dioxide. The manganese oxides other than manganese dioxide include, for example, MnO, Mn₃O₄, Mn₂O₃, and Mn₂O₇. The main constituent of the manganese oxides contained in the positive electrode is preferably manganese dioxide.

Lithium may be doped in a part of the manganese dioxide contained in the positive electrode. If the doping amount of lithium is small, a high capacity can be ensured. Manganese oxide in which a small amount of lithium is doped is expressed as LiₓMnO₂ (0≤x≤0.05). The average composition of the whole manganese oxides contained in the positive electrode is preferably LiₓMnO₂ (0≤x≤0.05). Generally, ratio x of lithium (Li) increases with the progress of discharge of the lithium primary battery. The ratio x of lithium (Li) is preferably 0.05 or less in the initial state of discharge of the lithium primary battery.

The positive electrode may contain any of the other positive electrode active materials that are generally used for the lithium primary batteries. An example of the other positive electrode active materials may be a graphite fluoride. The rate of LiₓMnO₂ occupying the entire positive electrode active material may preferably be 90% by mass or more.

Electrolytic manganese oxide may preferably be used as the manganese oxide. The electrolytic manganese oxide may have been treated as needed by at least one of a neutralizing treatment, a washing treatment, and a baking treatment. The electrolytic manganese oxide can generally be obtained by electrolysis of a manganese sulfate solution.

Conditions for the electrolytic synthesis of the electrolytic manganese oxide may be adjusted to raise the crystallinity degree of the manganese oxide, and to decrease the specific surface area of the electrolytic manganese oxide. The BET specific surface area of LiₓMnO₂ may be 10 m²/g or more and 50 m²/g or less, and may be 10 m²/g or more and 30 m²/g or less. The BET specific surface area of LiₓMnO₂ may be measured by a known method, and may, for example, be measured with a specific surface area analyzer (for example, a BET Specific Surface Area Analyzer made by MOUNTEC Co., Ltd.) based on the BET method. For example, LiₓMnO₂ separated from a positive electrode removed from a battery may be used as a specimen to be analyzed.

The average particle size of LiₓMnO₂ which is the positive electrode active material may preferably range from 20-50 μm. The average particle size here means the median diameter D50 on a volume basis and may be measured with a laser diffraction particle size distribution analyzer.

### Negative Electrode

The negative electrode contains, as a negative electrode active material, at least one selected from the group consisting of metal lithium and lithium alloy. The negative electrode may contain either a metal lithium or a lithium alloy, or may contain both of metal lithium and lithium alloy. For example, a compound containing metal lithium and lithium alloy may be used for the negative electrode.

The lithium alloy may not particularly be limited, and may be selected from alloys generally used as the negative electrode active materials for the lithium primary batteries. The Lithium alloys include, for example, Li—Al alloys, Li—Sn alloys, Li—Ni—Si alloys, and Li—Pb alloys. The content of one or more metal elements contained in the lithium alloy other than lithium may preferably range from 0.05% by mass to 15% by mass to ensure the charge capacity and stabilizing the internal resistance.

### Separator

The lithium primary battery includes a separator that intervenes between the positive electrode and the negative electrode. Material used as the separator may preferably be a porous sheet made of insulating material that has a tolerance against the internal environment of the lithium primary battery. Specifically, the separator may be a non-woven cloth made of synthetic resin, a microporous membrane made of synthetic resin, or a laminated body of these.

Synthetic resins used for the non-woven cloth include, for example, polypropylene, polyphenylene sulfide, and polybutylene terephthalate. Synthetic resin used for the microporous membrane may be a polyolefin resin, such as polyethylene, polypropylene, and ethylene-propylene copolymer. The microporous membrane may contain inorganic particles as needed.

### Electrolyte

Electrolyte 24 may not particularly be limited, and may be non-aquas electrolyte generally used for the lithium primary batteries. Solution that can be used as electrolyte 24 may, for example, be non-aquas electrolyte in which lithium salt or lithium ion is dissolved in a non-aquas solvent.

The non-aquas solvent may be any organic solvent that can generally be used for the non-aquas electrolyte of the lithium primary batteries. The non-aquas solvents include, for example, ethers, esters, and carbonic esters. Solvents that can be used as the non-aquas solvent include, for example, dimethyl ether, γ-butyrolactone, propylene carbonate, ethylene carbonate, and 1,2-dimethoxyethane. The non-aquas electrolyte may contain a single kind of non-aquas solvent or may contain two or more kinds of non-aquas solvents.

In order to enhance the discharge characteristics of the lithium primary battery, the non-aquas solvent may preferably contain cyclic carbonate ester having a high boiling point and a chain ether having a low viscosity at a low temperature. The cyclic carbonate ester may preferably contain at least one selected from the group consisting of propylene carbonate (PC) and ethylene carbonate (EC). The cyclic carbonate ester containing PC may be particularly preferable. The chain ether may preferably have a viscosity of 1 mPa's or lower at 25° C. The chain ether preferably contains dimethoxyethane (DME). The viscosity of the non-aquas solvent may be obtained by a measurement with a small sample viscometer m-VROC made by RheoSense, Inc. at a shear rate of 10000 1/s at temperature of 25° C.

The lithium salt that can be used may be those generally used as the solute in the lithium primary batteries. Such lithium salts include, for example, LiCF₃SO₃, LIN(CF₃SO₂)₂, LiCIO₄, LiBF₄, LiPF₆, LiRaSO₃ (Rₐ is a fluorinated alkyl group having a carbon number of one of 1 to 4), LiFSO₃, LiN(SO₂R_{b})(SO₂R_{c}) (Each of R_{b} and R_{c} is a fluorinated alkyl group independently having a carbon number of one of 1 to 4), LiN(FSO₂)₂, LiPO₂F₂, LiB(C₂O₄)₂, and LiBF₂(C₂O₄). Non-aquas electrolyte 24 may contain one of these lithium salts or may contain two or more of these lithium salts.

The concentration of lithium ions contained in electrolyte 24 (the total concentration of the lithium salts) may, for example, range from 0.2 mol/L to 2.0 mol/L or may range from 0.3 mol/L to 1.5 mol/L.

Electrolyte 24 may contain one or more additives as needed. The additives that can be added include, for example, propanesultone and vinylene carbonate. The total concentration of the additives contained in non-aquas electrolyte 24 may, for example, range from 0.003 mol/L to 5 mol/L.

### Case

Case 20 (positive electrode case 21 or the positive electrode can) may be made of, e.g., a conductive stainless steel.

The shape of case 20 of the lithium primary battery (i.e., the shape of the battery) may be a flat shape as a whole. Case 20 may, for example, be a flat rectangular shape or may be a coin shape (including a button shape). In a case where the lithium primary battery according to the present exemplary embodiment is a coin type lithium primary battery using case 20 having a coin shape, each of the positive electrode and the negative electrode typically has a circular disk shape.

Case 20 may include positive electrode case 21 configured to function as a positive terminal, sealing plate 22 configured to function as a negative terminal, and gasket 23 disposed between positive electrode case 21 and sealing plate 22. The material of gasket 23 may not particularly be limited, and may be material generally used for gasket 23. Examples of the material of gasket 23 include resins, such as polypropylene (PP), polyphenylene sulfide (PPS), perfluoroalkoxy alkane (PFA), and polyetheretherketone (PEEK).

### Examples

The lithium primary battery according to the present exemplary embodiment will be detailed along the following working examples. However, it should not be construed that the present invention is limited to the following working examples.

### Lithium Primary Batteries A1-A15 and B1-B6

### (1) Production of Positive Electrodes

An electrolytic manganese oxide, a conductive agent and a binder were mixed at a predetermined mass ratio, thereby preparing a positive electrode mixture. A carbon black and a graphite were used as the conductive agent. The graphite were selected from an expanded graphite having an average particle size of 50 μm, a thickness of about 3 μm, and an interlayer distance of about 50 nm, a flake graphite having an average particle size of 50 μm, a thickness of about 0.2 μm, and an interlayer distance of about 0.34 nm, and a graphene having an average particle size of 50 μm, a thickness of about 0.01 μm, and an interlayer distance of about 0.34 nm. PTFE or FEP were selectively used as the binder.

Plural (twelve) kinds of positive electrode mixtures which were different from one another in the composition of the conductive agent and/or the composition of the binder were produced and used as the positive electrode mixture for forming first portion 11A of the positive electrode or the positive electrode mixture for forming second portion 11B of the positive electrode. In each of the positive electrode mixtures, the content of the carbon black were constant, i.e., 1 part by mass with respect to 100 parts by mass of manganese oxide. TABLE 1 shows the kind and the content of the graphite contained in each positive electrode mixture. In TABLE 1, the content is indicated by a value of parts by mass with respect to 100 parts by mass of manganese oxide.

One of positive electrode mixtures X1-X6 among positive electrode mixtures X1-X12 shown in TABLE 1 was selected as the positive electrode mixture for forming first portion 11A. The positive electrode mixture for forming first portion 11A was put in a predetermined mold, and temporarily molded by a press-molding to obtain a temporal molded body with an annular shape. The temporal molded body had an outer diameter (diameter) of 14.5 mm, an inner diameter (diameter) of 13 mm, and a thickness (width) in the center axis direction of 1.9 mm.

Further, one of positive electrode mixtures X1-X6 was selected as the positive electrode mixture for forming second portion 11B. The temporal molded body was fit in a mold for forming the positive electrode pellet, and the inside of the temporal molded body (the part becoming the inside of the annular shape) was filled with the positive electrode mixture for forming second portion 11B. Then, a press-molding was performed to obtain positive electrode pellet 91 with a circular columnar shape having an outer diameter (diameter) of 14.5 mm and a height of 1.9 mm. First portion 11A and second portion 11B were distributed in positive electrode pellet 91 as shown in configuration example 1 shown in FIG. 2.

TABLE 1

| | Graphite | | Binder | |
|---|---|---|---|---|
| | | Parts by Mass | | Parts by Mass |
| | | with Respect to | | with Respect to |
| | | 100 Parts by | | 100 Parts by |
| Positive | | Mass of Positive | | Mass of Positive |
| Electrode | | Electrode Active | | Electrode Active |
| Mixture | Material | Material | Material | Material |
| X1 | — | 0 | PTFE | 2 |
| X2 | Expanded | 2 | PTFE | 2 |
| | Graphite | | | |
| X3 | Expanded | 4 | PTFE | 2 |
| | Graphite | | | |
| X4 | Expanded | 6 | PTFE | 2 |
| | Graphite | | | |
| X5 | Expanded | 8 | PTFE | 2 |
| | Graphite | | | |
| X6 | Expanded | 10 | PTFE | 2 |
| | Graphite | | | |
| X7 | — | 0 | FEP | 2 |
| X8 | Expanded | 8 | FEP | 2 |
| | Graphite | | | |
| X9 | Graphene | 2 | PTFE | 2 |
| X10 | Graphene | 10 | PTFE | 2 |
| X11 | Flake | 2 | PTFE | 2 |
| | Graphite | | | |
| X12 | Flake | 10 | PTFE | 2 |
| | Graphite | | | |

### (2) Production of Negative Electrodes

A metal lithium plate was punched to obtain a negative electrode with a circular disk shape having a diameter of 16 mm and a thickness of 0.8 mm.

### (3) Preparation of Non-Aquas Electrolyte

Propylene carbonate (PC) and 1, 2-dimetoxyethane (DME) were mixed at a volume ratio of 1:1 to obtain a non-aquas solvent. Lithium perchlorate (LiClO₄) was dissolved in the non-aquas solvent at the concentration of 0.5 mol/L, thus preparing non-aquas electrolyte 24.

### (4) Assembling Lithium Primary Batteries

A non-woven cloth made of polypropylene (a thickness of 0.5 mm) was prepared as a separator. Gasket 23 made of polypropylene was prepared. A conductive stainless steel having a thickness of 0.2 mm was punched to form positive electrode case 21. A conductive stainless steel having a thickness of 0.25 mm was punched to form sealing plate 22. A flat lithium primary battery (CR2032 type) having a configuration as shown in FIG. 1A was assembled using these components including positive electrode pellet 91, the negative electrode, electrolyte 24, the separator, positive electrode case 21, gasket 23 and sealing plate 22.

Lithium primary batteries A1-A15 and B1-B6 which were different in the configurations of first portion 11A and second portion 11B were produced for testing as described above, and evaluated as described below.

### (5) Evaluation

### Discharge Capacity

The discharge capacity was measured by a discharge test in compliance with JIS C 8515:2017.

The produced lithium primary batteries were placed in an environment at 20° C. Each lithium primary battery was connected to a load resistor of 15 kΩ and discharged. The discharge were continued until the inter-terminal voltage reached 2.0 V. The quantity of charges discharged and flown until the inter-terminal voltage reached 2.0 V was measured. The quantities of discharged charges were measured for ten lithium primary batteries and an average value of the quantities were determined as a discharge capacity (mAh).

### Measurement of Degree of Expansion of Positive Electrode

Each of the batteries after measuring the discharge capacity was disassembled to take out positive electrode pellet 91. Positive electrode pellet 91 was placed so that top surface 1A was on the lower side and center axis direction 11C coincided with the vertical direction. In this state, height h1 of positive electrode pellet 91 at the center of bottom surface 1B of positive electrode pellet 91 and height h2 of positive electrode pellet 91 at the side circumference of positive electrode pellet 91 were measured. Height h2 at the side circumference was obtained by measuring heights at four points which were located at intervals of a constant angle of 90 degrees in circumferential direction Dc on a middle circumference between the inner circumference and the outer circumference of annular portion 11P of first portion 11A, where the distance to the middle circumference from center axis 11C was a middle of the distance to the inner circumference and the distance to the outer circumference, and averaging the heights measured at the four points. Height difference Δh (mm) between the center position and the side circumference position of bottom surface 1B was obtained by a calculation expressed as Δh=h1−h2.

The height differences Δh were measured for ten lithium primary batteries, and an average of them were evaluated as a degree of expansion Δ (mm).

Results of the evaluations are shown in TABLE 2. Positive electrode mixtures X1 to X6 were, as shown in TABLE 1, the same in the material and the content of the binder contained in each positive electrode mixture and different from one another in only the content of the graphite (the expanded graphite) contained as the conductive agent. TABLE 2 further shows the positive electrode mixture used for each lithium primary battery and the content of the graphite in the positive electrode mixture.

TABLE 2

| | First Portion | | Second Portion | | | |
|---|---|---|---|---|---|---|
| | | Content of | | Content of | | |
| | | Graphite | | Graphite | | |
| | | (Parts by Mass | | (Parts by Mass | | |
| | | with Respect to | | with Respect to | | |
| | | 100 Parts by | | 100 Parts by | | |
| | Positive | Mass of Positive | Positive | Mass of Positive | Discharge | |
| | Electrode | Electrode Active | Electrode | Electrode Active | Capacity | Expansion |
| Battery | Mixture | Material) | Mixture | Material) | (mAh) | Δ (mm) |
| B1 | X1 | 0 | X1 | 0 | 220 | 0 |
| A1 | X1 | 0 | X2 | 2 | 231 | 0.03 |
| A2 | X1 | 0 | X3 | 4 | 240 | 0.1 |
| A3 | X1 | 6 | X4 | 6 | 245 | 0.12 |
| A4 | X1 | 0 | X5 | 8 | 250 | 0.14 |
| A5 | X1 | 0 | X6 | 10 | 250 | 0.14 |
| B2 | X2 | 2 | X2 | 2 | 218 | 0 |
| A6 | X2 | 2 | X3 | 4 | 230 | 0.04 |
| A7 | X2 | 2 | X4 | 6 | 240 | 0.1 |
| A8 | X2 | 2 | X5 | 8 | 245 | 0.12 |
| A9 | X2 | 2 | X6 | 10 | 250 | 0.14 |
| B3 | X3 | 4 | X3 | 4 | 216 | 0 |
| A10 | X3 | 4 | X4 | 6 | 230 | 0.03 |
| A11 | X3 | 4 | X5 | 8 | 240 | 0.1 |
| A12 | X3 | 4 | X6 | 10 | 245 | 0.12 |
| B4 | X4 | 6 | X4 | 6 | 214 | 0 |
| A13 | X4 | 6 | X5 | 8 | 230 | 0.04 |
| A14 | X4 | 6 | X6 | 10 | 235 | 0.09 |
| B5 | X5 | 8 | X5 | 8 | 212 | 0 |
| A15 | X5 | 8 | X6 | 10 | 230 | 0.03 |
| B6 | X6 | 10 | X6 | 10 | 210 | 0 |

In lithium primary batteries B1-B6, the composition of the positive electrode mixture in first portion 11A is the same as second portion 11B, and the content of the graphite first portion 11A is the same as second portion 11B. In this case, there is no difference in the expansion coefficient between first portion 11A and second portion 11B, and degree of expansion Δ is substantially zero (0). The discharge capacity is small. Lithium primary batteries B1-B6 tend to have the discharge capacity decreasing as the content of the graphite is increased to cause positive electrode pellet 91 more likely to expand. The reason for this may be that positive electrode case 21 expands due to the uniform expansion of the entire positive electrode pellet 91, so that the electrical connection between positive pellet 91 and positive electrode case 21 becomes more likely to be cut at the center of positive electrode pellet 91.

In Lithium primary batteries A1-A15, on the other hand, the discharge capacity was improved by allowing the content of the graphite in second portion 11B to be higher than that in first portion 11A (allowing the content of the graphite in first portion 11A to be lower than that in second portion 11B). In lithium primary batteries A1-A15, the center of positive electrode pellet 91 expands more than the circumference, and thus the degree of expansion Δ takes a positive value. Accordingly, it can be thought that, even when positive electrode case 21 expands due to the expansion of the positive electrode, the electrical connection between positive electrode pellet 91 and positive electrode case 21 is maintained, so that the discharge capacity can be maintained high.

In particular, the discharge capacity was remarkably improved in lithium primary batteries A2-A5, A7-A9, A11, A12, and A14, in which the difference of the content of the graphite between second portion 11B and first portion 11A was 4 parts by mass or more with respect to 100 parts by mass of the positive electrode active material.

As the content of the graphite in first portion 11A and second portion 11B is increased, positive electrode pellet 91 becomes more likely to expand, so that electrolyte 24 is more likely to be absorbed into positive electrode pellet 91. As a result, electrolyte 24 held in the separator decreases, which may cause an increase in the internal resistance and a reduction in the discharge capacity. However, as shown in TABLE 2, the discharge capacity is maintained high in the condition that the content of the graphite in first portion 11A is in the range of 4 parts by mass or lower with respect to 100 parts by mass of the positive electrode active material.

### Lithium Primary Batteries A16-A18 and B7

In lithium primary batteries B1, A1 and A5, the positive electrode mixture used for forming first portion 11A was changed from X1 to X7. In other words, the binder contained in first portion 11A was changed from PTFE to FEP. The other conditions except for this change are the same as lithium primary batteries B1, A1 and A5, respectively, and lithium primary batteries B7, A16 and A17 were produced and evaluated in the same manner as the above.

In lithium primary battery A15, the positive electrode mixture used for forming first portion 11A was changed from X5 to X8. In other words, the binder contained in first portion 11A was changed from PTFE to FEP. The other conditions except for this change are the same as lithium primary battery A15, and lithium primary battery A18 was produced and evaluated in the same manner as the above.

Results of the evaluations are shown in TABLE 3. Comparing the evaluation results shown in TABLE 3 to the evaluation results of lithium primary batteries B1, A1, A5 and A15 shown in TABLE 2, it can be found that the discharge capacity is improved by using FEP for the binder contained in first portion 11A.

TABLE 3

| | First Portion | | Second Portion | | | |
|---|---|---|---|---|---|---|
| | | Content of | | Content of | | |
| | | Graphite | | Graphite | | |
| | | (Parts by Mass | | (Parts by Mass | | |
| | | with Respect to | | with Respect to | | |
| | | 100 Parts by | | 100 Parts by | | |
| | Positive | Mass of Positive | Positive | Mass of Positive | Discharge | |
| | Electrode | Electrode Active | Electrode | Electrode Active | Capacity | Expansion |
| Battery | Mixture | Material) | Mixture | Material) | (mAh) | Δ (mm) |
| B7 | X7 | 0 | X1 | 0 | 221 | 0 |
| A16 | X7 | 0 | X2 | 2 | 236 | 0.07 |
| A17 | X7 | 0 | X6 | 10 | 252 | 0.16 |
| A18 | X8 | 8 | X6 | 10 | 235 | 0.06 |

### Lithium Primary Batteries A19-A27

In the process of obtaining the temporal molded body having an annular shape using the positive electrode mixture for forming first portion 11A in the production of the positive electrode, the inner diameter (diameter) of the temporal molded body was changed from 13 mm to 11 mm, 9 mm, and 7 mm to prepare plural kinds of positive electrode pellets 91 that are different from one another in the volume ratio of first portion 11A and second portion 11B.

Using positive electrode mixture X1 to form first portion 11A and using positive electrode mixture X2 to form second portion 11B, lithium primary battery A19 with first portion 11A having an inner diameter (diameter) of 11 mm, lithium primary battery A20 with first portion 11A having an inner diameter (diameter) of 9 mm, and lithium primary battery A21 with first portion 11A having an inner diameter (diameter) of 7 mm were produced in the same manner as lithium primary battery A1, and evaluated in the same manner as the above.

Using positive electrode mixture X1 to form first portion 11A and using positive electrode mixture X6 to form second portion 11B, lithium primary battery A22 with first portion 11A having an inner diameter (diameter) of 11 mm, lithium primary battery A23 with first portion 11A having an inner diameter (diameter) of 9 mm, and lithium primary battery A24 with first portion 11A having an inner diameter (diameter) of 7 mm were produced in the same manner as lithium primary battery A5, and evaluated in the same manner as the above.

Using positive electrode mixture X5 to form first portion 11A and using positive electrode mixture X6 to form second portion 11B, lithium primary battery A25 with first portion 11A having an inner diameter (diameter) of 11 mm, lithium primary battery A26 with first portion 11A having an inner diameter (diameter) of 9 mm, and lithium primary battery A27 with first portion 11A having an inner diameter (diameter) of 7 mm were produced in the same manner as lithium primary battery A15, and evaluated in the same manner as the above.

Results of the evaluations are shown in TABLE 4. TABLE 4 also shows values of R₁/R₂, where R₁ is an inner diameter (diameter) of first portion 11A, and R₂ is an outer diameter (diameter) of first portion 11A (the outer diameter of positive electrode pellet 91). TABLE 4 further shows the evaluation results of lithium primary batteries A1, A5 and A15 duplicated from TABLE 2. It can be found from TABLE 4 that a high discharge capacity is easily obtained in a condition that R₁ ranges from 50% to 90% of R₂ (in other words, in a condition in which distance from center axis 11C of positive electrode pellet 91 to the border between first portion 11A and second portion 11B ranges from 50% to 90% of the radius of positive electrode pellet 91). Also, a remarkably high discharge capacity is realized in a condition that R₁ ranges from 60% to 80% of R₂.

TABLE 4

| | Content of Graphite | | | | | |
|---|---|---|---|---|---|---|
| | (Parts by Mass with | | | | | |
| | Respect to 100 Parts | | | | | |
| | by Mass of Positive | | | | | |
| | Electrode Active Material) | | Inner Diameter | | Discharge | |
| | First | Second | of First Portion | R₁/R₂ | Capacity | Expansion |
| Battery | Portion | Portion | R₁ (mm) | (%) | (mAh) | Δ (mm) |
| A1 | 0 | 2 | 13 | 90 | 231 | 0.03 |
| A19 | 0 | 2 | 11 | 76 | 232 | 0.05 |
| A20 | 0 | 2 | 9 | 62 | 234 | 0.06 |
| A21 | 0 | 2 | 7 | 48 | 230 | 0.03 |
| A5 | 0 | 10 | 13 | 90 | 250 | 0.14 |
| A22 | 0 | 10 | 11 | 76 | 251 | 0.15 |
| A23 | 0 | 10 | 9 | 62 | 252 | 0.15 |
| A24 | 0 | 10 | 7 | 48 | 249 | 0.13 |
| A15 | 8 | 10 | 13 | 90 | 230 | 0.03 |
| A25 | 8 | 10 | 11 | 76 | 232 | 0.05 |
| A26 | 8 | 10 | 9 | 62 | 233 | 0.06 |
| A27 | 8 | 10 | 7 | 48 | 231 | 0.04 |

### Lithium Primary Batteries A29-A31

In lithium primary battery A1, the positive electrode mixture used for forming second portion 11B was changed from X2 to X9 or X11. In other words, the kind of the graphite contained in second portion 11B was changed from the expanded graphite to the graphene or the flake graphite. The other conditions except for this change are the same as lithium primary battery A1, and lithium primary battery A28 with second portion 11B containing the graphene and lithium primary battery A29 with second portion 11B containing the flake graphite were produced and evaluated in the same manner as the above.

Further, in lithium primary battery A5, the positive electrode mixture used for forming second portion 11B was changed from X6 to X10 or X12. In other words, the kind of the graphite contained in second portion 11B was changed from the expanded graphite to the graphene or the flake graphite. The other conditions except for this change to be the same as lithium primary battery A5, and lithium primary battery A30 with second portion 11B containing the graphene and lithium primary battery A31 with second portion 11B containing the flake graphite were produced and evaluated in the same manner as the above.

Results of the evaluations are shown in TABLE 5. TABLE 5 further shows the evaluation results of lithium primary batteries A1 and A5 duplicated from TABLE 2.

TABLE 5

| | Content of Graphite | | | | |
|---|---|---|---|---|---|
| | (Parts by Mass | | | | |
| | with Respect to | | | | |
| | 100 Parts by Mass of | | | | |
| | Positive Electrode | | | | |
| | Active Material) | | Graphite of | Discharge | |
| | First | Second | Second | Capacity | Expansion |
| Battery | Portion | Portion | Portion | (mAh) | Δ (mm) |
| A1 | 0 | 2 | Expanded | 231 | 0.03 |
| | | | Graphite | | |
| A28 | 0 | 2 | Graphene | 230 | 0.05 |
| A29 | 0 | 2 | Flake | 230 | 0.06 |
| | | | Graphite | | |
| A5 | 0 | 10 | Expanded | 250 | 0.14 |
| | | | Graphite | | |
| A30 | 0 | 10 | Graphene | 248 | 0.13 |
| A31 | 0 | 10 | Flake | 246 | 0.13 |
| | | | Graphite | | |

### Lithium Primary Batteries A32-A37

First portion 11A was formed using positive electrode mixture X1, and second portion 11B was formed using positive electrode mixture X2. In the step of obtaining the ring-shape temporal molded body using the positive electrode mixture for forming first portion 11A in production of the positive electrode, the thickness (width) of the temporal molded body in the center axis direction was changed from 1.9 mm to 0.95 mm or 0.80 mm.

The temporal molded body was fit in a mold for forming positive electrode pellet 91, and the remaining portion unoccupied by the temporal molded body was filled with the positive electrode mixture for forming second portion 11B. Then, a press-molding was performed to obtain positive electrode pellet 91 with a circular columnar shape having an outer diameter (diameter) of 14.5 mm and a height of 1.9 mm.

The other conditions except for the above-described changes are the same as lithium primary battery A1, and lithium primary batteries A32-A37 were produced and evaluated in the same manner as the above. The pattern of distributing first portion 11A and second portion 11B inside positive electrode pellet 91 in each of lithium primary batteries A32-A37 was the same as configuration example 2 or 3 shown in FIG. 2 or configuration example 6 shown in FIG. 3.

Results of the evaluations are shown in TABLE 6. TABLE 6 further shows values of thickness d of first portion 11A constituting annular portion 11P in center axis direction Da, and values of ratio d/D of a thickness d to a thickness D of positive electrode pellet 91 in center axis direction Da. TABLE 6 further shows the evaluation results of lithium primary battery A1 duplicated from TABLE 2. As shown in TABLE 6, thickness d of first portion 11A constituting annular portion 11P in center axis direction Da may be, as an adequate level, 40% or more of thickness D of positive electrode pellet 91, and may preferably be 50% or more of thickness D of positive electrode pellet 91.

TABLE 6

| | | Thickness | | | |
|---|---|---|---|---|---|
| | | of Annular | | | |
| | | Portion of | | | |
| | Shapes of | First | Ratio of | Discharge | |
| | Fist Portion and | Portion | Thickness | Capacity | Expansion |
| Battery | Second Portion | d (mm) | d/D (%) | (mAh) | Δ (mm) |
| A1 | Configuration | 1.9 | 100 | 231 | 0.03 |
| | Example 1 | | | | |
| A32 | Configuration | 0.95 | 50 | 230 | 0.03 |
| | Example 2 | | | | |
| A33 | Configuration | 0.8 | 42 | 230 | 0.02 |
| | Example 2 | | | | |
| A34 | Configuration | 0.95 | 50 | 231 | 0.03 |
| | Example 3 | | | | |
| A35 | Configuration | 0.8 | 42 | 231 | 0.03 |
| | Example 3 | | | | |
| A36 | Configuration | 0.95 | 50 | 230 | 0.03 |
| | Example 6 | | | | |
| A37 | Configuration | 0.8 | 42 | 230 | 0.04 |
| | Example 6 | | | | |

### Lithium Primary Batteries A38-A41

First portion 11A was formed using positive electrode mixture X1, and second portion 11B was formed using positive electrode mixture X2. Positive electrode mixture X2 was put in a predetermined mold, and temporarily molded by pressing to obtain a temporal molded body with a pellet shape, or second portion 11B. The temporal molded body had an outer diameter (diameter) of 13 mm, and a thickness (width) of 0.95 mm or 0.80 mm in center axis direction Da.

The temporal molded body was put in the middle of a mold for forming positive electrode pellet 91, and the remaining portion unoccupied by the temporal molded body was filled with positive electrode mixture X1 for forming first portion 11A. A press-molding was performed to obtain positive electrode pellet 91 with a circular columnar shape having an outer diameter (diameter) of 14.5 mm and a height of 1.9 mm.

Lithium primary batteries A38-A41 were thus produced and evaluated in the same manner as the above. Lithium primary batteries A38-A41 were similar to lithium primary battery A1 except for the pattern of distributing first portion 11A and second portion 11B inside positive electrode pellet 91 that is expressed by configuration example 4 or 5 shown in FIG. 3.

Results of the evaluations are shown in TABLE 7. TABLE 7 further shows values of thickness d of second portion 11B in center axis direction Da, and values of ratio d/D of thickness d to thickness D of positive electrode pellet 91 in center axis direction Da. TABLE 7 further shows the evaluation results of lithium primary battery A1 duplicated from TABLE 2. As shown in TABLE 7, thickness d of second portion 11B in center axis direction Da may be, as an adequate level, 40% or more of thickness D of positive electrode pellet 91, and may preferably be 50% or more of thickness D of positive electrode pellet 91.

TABLE 7

| | | Thickness | | | |
|---|---|---|---|---|---|
| | | of Annular | | | |
| | | Portion of | | | |
| | Shapes of | First | Ratio of | Discharge | |
| | Fist Portion and | Portion | Thickness | Capacity | Expansion |
| Battery | Second Portion | d (mm) | d/D (%) | (mAh) | Δ (mm) |
| A1 | Configuration | 1.9 | 100 | 231 | 0.03 |
| | Example 1 | | | | |
| A38 | Configuration | 0.95 | 50 | 230 | 0.03 |
| | Example 4 | | | | |
| A39 | Configuration | 0.8 | 42 | 231 | 0.04 |
| | Example 4 | | | | |
| A40 | Configuration | 0.95 | 50 | 231 | 0.04 |
| | Example 5 | | | | |
| A41 | Configuration | 0.8 | 42 | 230 | 0.03 |
| | Example 5 | | | | |

### Lithium Primary Batteries A42-A47

First portion 11A was formed using positive electrode mixture X1, and second portion 11B was formed using positive electrode mixture X6. The other conditions except for this change are the same as lithium primary batteries A32 to A37, respectively, while changing thickness d of first portion 11A constituting annular portion 11P in center axis direction Da, and lithium primary batteries A42-A47 were produced and evaluated in the same manner as the above. In other words, lithium primary batteries A42-A47 were different from lithium primary batteries A32-A 37, respectively, in that the content of the graphite in second portion 11B was changed from 2 parts by mass to 10 parts by mass with respect to 100 parts by mass of the positive electrode active material.

Results of the evaluations are shown in TABLE 8. TABLE 8 also shows values of thickness d of first portion 11A in the center axis direction, and values of ratio d/D of thickness d to thickness D of positive electrode pellet 91 in center axis direction Da. TABLE 8 further shows the evaluation results of lithium primary battery A5 duplicated from TABLE 2. As shown in TABLE 8, thickness d of first portion 11A in center axis direction Da may be, as an adequate level, 40% or more of thickness D of positive electrode pellet 91, and may preferably be 50% or more of thickness D of positive electrode pellet 91.

TABLE 8

| | | Thickness | | | |
|---|---|---|---|---|---|
| | | of Annular | | | |
| | | Portion of | | | |
| | Shapes of | First | Ratio of | Discharge | |
| | Fist Portion and | Portion | Thickness | Capacity | Expansion |
| Battery | Second Portion | d (mm) | d/D (%) | (mAh) | Δ (mm) |
| A5 | Configuration | 1.9 | 100 | 250 | 0.14 |
| | Example 1 | | | | |
| A42 | Configuration | 0.95 | 50 | 245 | 0.12 |
| | Example 2 | | | | |
| A43 | Configuration | 0.8 | 42 | 240 | 0.11 |
| | Example 2 | | | | |
| A44 | Configuration | 0.95 | 50 | 245 | 0.13 |
| | Example 3 | | | | |
| A45 | Configuration | 0.8 | 42 | 240 | 0.10 |
| | Example 3 | | | | |
| A46 | Configuration | 0.95 | 50 | 232 | 0.03 |
| | Example 6 | | | | |
| A47 | Configuration | 0.8 | 42 | 231 | 0.02 |
| | Example 6 | | | | |

### Lithium Primary Batteries A48-A51

First portion 11A was formed using positive electrode mixture X1, and second portion 11B was formed using positive electrode mixture X6. The other conditions except for this change are the same as lithium primary batteries A38-A41, respectively, while changing thickness d of second portion 11B in center axis direction Da, and lithium primary batteries A48-A51 were produced and evaluated in the same manner as the above. In other words, lithium primary batteries A48-A51 were different from lithium primary batteries A38-A41, respectively, in that the content of the graphite in second portion 11B was changed from 2 parts by mass to 10 parts by mass with respect to 100 parts by mass of the positive electrode active material.

Results of the evaluations are shown in TABLE 9. TABLE 9 further shows values of thickness d of second portion 11B in center axis direction Da, and values of ratio d/D of thickness d to thickness D of positive electrode pellet 91 in center axis direction Da. TABLE 9 further shows the evaluation results of lithium primary battery A5 duplicated from TABLE 2. As shown in TABLE 9, a high discharge capacity is obtained in the case where thickness d of second portion 11B in center axis direction Da is 40% or more of thickness D of positive electrode pellet 91, and that a higher discharge capacity is obtained in the case where thickness d of second portion 11B in center axis direction Da is 50% or more of thickness D of positive electrode pellet 91.

TABLE 9

| | | Thickness | | | |
|---|---|---|---|---|---|
| | | of Annular | | | |
| | | Portion of | | | |
| | Shapes of | First | Ratio of | Discharge | |
| | Fist Portion and | Portion | Thickness | Capacity | Expansion |
| Battery | Second Portion | d (mm) | d/D (%) | (mAh) | Δ (mm) |
| A5 | Configuration | 1.9 | 100 | 250 | 0.14 |
| | Example 1 | | | | |
| A48 | Configuration | 0.95 | 50 | 240 | 0.10 |
| | Example 4 | | | | |
| A49 | Configuration | 0.8 | 42 | 235 | 0.04 |
| | Example 4 | | | | |
| A50 | Configuration | 0.95 | 50 | 240 | 0.11 |
| | Example 5 | | | | |
| A51 | Configuration | 0.8 | 42 | 235 | 0.04 |
| | Example 5 | | | | |

In the above-described exemplary embodiment, the terms indicating the directions such, for example, as “vertical direction”, “top surface” and “bottom surface” show relative directions determined solely by relative positional relations of the structural elements such, for example, as the positive electrode and the negative electrode of the flat lithium primary battery, and do not show absolute directions such, for example, as the direction of a plumb line.

### INDUSTRIAL APPLICABILITY

The present disclosure is applicable to the flat lithium primary batteries.

### REFERENCE MARKS IN THE DRAWINGS

10 flat lithium primary battery
11 positive electrode
11A first portion
11B second portion
11C center axis
1C side circumferential surface
12 separator
13 negative electrode
20 case
21 positive electrode case
22 sealing plate
23 gasket
91 positive electrode pellet

1. A flat lithium primary battery comprising a case, a positive electrode, a negative electrode, a separator, and a non-aqueous electrolyte, the case accommodating therein the positive electrode, the negative electrode, the separator, and the non-aqueous electrolyte, wherein
the positive electrode includes a positive electrode pellet containing positive electrode active material, conductive agent, and binder, the positive electrode pellet having a circular columnar shape having a side circumferential surface extending in a circumferential direction surrounding a center axis extending in a center axis direction,
the conductive agent contains graphite,
the positive electrode pellet is divided into a first portion and a second portion, the first portion including at least a part of the side circumferential surface of the circular columnar shape,
the first portion includes an annular portion surrounding at least a part of the second portion, and
a content of the graphite in the second portion of the positive electrode pellet is higher than in the first portion of the positive electrode pellet.

2. The flat lithium primary battery according to claim 1, wherein the at least the part of the side circumferential surface of the circular columnar shape included in the first portion of the positive electrode pellet surrounds the center axis over an entire circumference of the side circumferential surface in the circumferential direction.

3. The flat lithium primary battery according to claim 1, wherein a content of the graphite in the second portion of the positive electrode pellet with respect to 100 parts by mass of the positive electrode active material is higher than a content of the graphite in the first portion of the positive electrode pellet with respect to 100 parts by mass of the positive electrode active material by 4 parts by mass or more of the positive electrode active material.

4. The flat lithium primary battery according to claim 1, wherein a content of the graphite in the first portion of the positive electrode active material with respect to 100 parts by mass of the positive electrode active material is 4 parts by mass or less.

5. The flat lithium primary battery according to claim 1, wherein a border between the annular portion and the second portion in the positive electrode pellet is located at a position where a distance from the center axis of the positive electrode pellet is 60% or more of a radius of the positive electrode pellet.

6. A flat lithium primary battery according to claim 1, wherein a distance from the center axis of the positive electrode pellet to a border between the annular portion and the second portion inside the positive electrode pellet is 80% or less of a radius of the positive electrode pellet.

7. The flat lithium primary battery according to claim 1, wherein a width of the second portion of the positive electrode pellet at the center axis of the positive electrode pellet in the center axis direction is 50% or more of a thickness of the positive electrode pellet.

8. The flat lithium primary battery according to claim 1, wherein a width of the annular portion in the center axis direction of the positive electrode pellet is 50% or more of a thickness of the positive electrode pellet.

9. The flat lithium primary battery according to claim 1, wherein
the first portion contains fluorinated-ethylene-propylene as the binder, and
the second portion contains polytetrafluoroethylene as the binder.

10. The flat lithium primary battery according to claim 1, wherein the graphite contains at least one selected from the group consisting of expanded graphite, flake graphite and graphene.

11. The flat lithium primary battery according to claim 10, wherein the graphite contains the expanded graphite.

12. The flat lithium primary battery according to claim 1, wherein the positive electrode active material contains manganese oxide.
